(19) United States
(12) Patent Application Publication
(10) Pub. No.: US 2026/0309745 A1
(43) Pub. Date: Oct. 8, 2026

(54) Holding Device and Method for Probe Microscopy and Optical Methods

(71) Applicant: Bruker Nano GmbH, Berlin (DE)

(72) Inventors: Torsten Müller, Berlin (DE); André Körnig, Berlin (DE); Jonas Hiller, Berlin (DE); Detlef Knebel, Berlin (DE)

(21) Appl. No.: 19/638,451

(22) Filed: Apr. 3, 2026

(30) Foreign Application Priority Data
Apr. 8, 2025 (DE) 10 2025 113 838.9
Aug. 15, 2025 (DE) 10 2025 132 716.5

(51) Int. Cl. G01Q 30/20; G01Q 30/02

(52) U.S. Cl. CPC G01Q 30/20; G01Q 30/025

(57) ABSTRACT

The invention relates to a holding device and a method for probe microscopy and optical methods. The holding device has the following: an at least partially transparently formed first layer for receiving a sample which can be examined by means of a probe microscope probe guided from above, and a second layer below the first layer for stabilizing the first layer, wherein the second layer has an opening for optical methods which is formed with at least two partial openings which are separated from one another by at least one bridge.

### BACKGROUND OF THE INVENTION

### Field of the Invention

The invention relates to a holding device and a method for probe microscopy and optical methods.

In probe microscopy, a sample is examined by means of a probe such as, for example, a cantilever or by means of a particle held with a laser. By means of this examination method, for example, material properties such as chemical properties, magnetic, electrical or optical properties or else the topography of the sample can be determined. A very well-known representative of these methods is the scanning force microscope (SFM), in which the sample is scanned with a fine tip, which is attached to a soft beam—the cantilever—in order to record the surface with high accuracy. Further probe microscopes are, for example, optical tweezers or a tunnel microscope.

Frequently, the sample to be examined is fixed on a support or the sample is restricted in its movement at least by this support. The sample itself can be active in this case. For example, it can be a protein whose active area is still accessible, or a cell for which the support represents a natural adhesion. A possible movement of the sample is entirely desired in this case and should optionally also be observed, but the support should be as immovable as possible so that it does not disturb the observation.

For orientation or else for further examination of the sample, at least one further examination method, such as, for example, an optical microscopy method, is often carried out promptly subsequently or else simultaneously. For the case in which the sample is transparent for the further examination method, it can be advantageous to bring it up to the sample from below. Depending on the method, the support should be transparent. Furthermore, with regard to the resolution of the further examination method, it can be advantageous if the support is very thin, as is the case, for instance, with a coverslip in the context of an optical examination with an inverse optical microscope (IOM).

However, a thin support has the disadvantage that it can be excited by the surroundings or by one of the examination methods itself to movements, such as, for example, vibrations, and the actual measurement is disturbed or influenced to a greater or lesser extent.

By reducing the optically accessible aperture, that is to say the opening which is available to the further examination method, by means of a stable support, stabilization of the thin support can be achieved—however with the disadvantage that, for example, all objectives can no longer be selected, because, for instance, the working distance of the objective is smaller than the thickness of the stable support, and the area for sample preparation is greatly restricted.

### SUMMARY OF THE INVENTION

The object of the invention is to specify a holding device and a method for probe microscopy and optical methods which make it possible to reduce or avoid the abovementioned problems.

The object is achieved by a holding device and a method for probe microscopy and optical methods according to the independent claims. The dependent claims relate to further embodiments.

According to a first aspect of the invention, a holding device for probe microscopy and optical methods has the following: an at least partially transparently formed first layer for receiving a sample which can be examined by means of a probe microscope probe guided from above, and a second layer below the first layer for stabilizing the first layer, wherein the second layer has an opening for optical methods which is formed with at least two partial openings which are separated from one another by at least one bridge (web).

According to a further aspect, a method for probe microscopy and optical methods has the following: providing an at least partially transparently formed first layer and a sample on the first layer, providing a second layer below the first layer for stabilizing the first layer, wherein the second layer has an opening which is formed with at least two partial openings which are separated from one another by at least one bridge, and examining and/or manipulating the sample by means of a probe microscope probe guided from above and by means of an optical device through the opening and/or the partial openings.

By means of the formation according to the invention of a plurality of partial openings in the second layer together with at least one bridge, the first layer can be stabilized, such that, for instance, vibrations of the first layer can be reduced and corresponding disturbing influences on microscopic measurements of the sample can be minimized. At the same time, in the case of a plurality of partial openings of the stabilizing second layer, a larger preparation area can be provided on the first layer with the same or improved stability for optical microscopy.

The optical methods can comprise optical examination methods and/or optical manipulation methods. In particular, the optical methods can comprise microscopic methods. For example, the optical methods can comprise at least one of light microscopy, fluorescence microscopy, spectroscopy and optical tweezers. The optical device can have at least one of a light microscope, a fluorescence microscope, a spectroscopy device, and an optical tweezer.

The opening can be formed with at least three partial openings, in particular at least four partial openings, in particular at least five partial openings. The opening can be formed with at most ten partial openings. The second layer can have at least two, at least three, at least four, or at least five bridges. For example, at most 20 or at most ten bridges can be provided. (In each case) two adjacent partial openings can be separated by a bridge.

The partial openings can have (substantially) equally large (cross-sectional) areas. Alternatively, at least two (or all) of the partial openings can have differently large (cross-sectional) areas. For example, a smallest of the partial openings can have an area of at most 50%, in particular of at most 30% of an area of a largest of the partial openings. Regions of the sample which correspond to smaller partial openings can be examined with increased stability. On the other hand, resolution and accessibility can be reduced.

The opening can be formed polygonally (in particular squarely) or circularly. Thus, the partial openings can together form a polygon (in particular a square) or a circle. The bridge (web) or the bridges (webs) can extend rectilinearly (without curvature). Alternatively, the bridge or the bridges can have at least one curved section.

The bridge or the bridges can extend along the (entire) opening. Alternatively, the bridges can extend up to a center point of the opening. The bridge or the bridges can intersect the center point of the openings. For example, the bridges can extend radially from the center point of the opening to an edge of the opening. The partial openings can thus be formed in the shape of a sector of a circle. In this case, the partial openings can cover the same or different center point angles. In the case of four partial openings, the second layer can be formed with two bridges crossing (at the center point of the opening). In a similar manner, the second layer can be formed with four bridges extending from the center point, wherein tangentially adjacent bridges are orthogonal to one another.

The bridges can also form a network, in particular a (honeycomb)-shaped network, wherein the partial openings are in particular formed in a honeycomb shape. Such a network is suitable, for example, for smaller samples such as proteins for which the corresponding partial openings can be small. The necessary access is provided due to the small expansion of proteins.

A bridge width can be between 0.1 mm and 2.0 mm, in particular between 0.3 mm and 1.0 mm. For example, the bridge width can be between 1% and 25%, in particular between 5% and 10%, of a diameter and/or a length and/or a width of the opening.

The at least one bridge and/or the second layer can be configured to (mechanically) stabilize the first layer, in particular with respect to vibrations in the first layer. For example, the first layer and the second layer can be connected to one another in a planar manner directly or by means of an intermediate layer (connecting layer), in particular in the region of the at least one bridge. Specifically, the first layer can lie directly (and in a planar manner) on the second layer and in particular the at least one bridge. The intermediate layer can be, for instance, a (thin) adhesive layer or heat-conducting layer.

The first layer and the second layer can be formed in a planar manner (in particular on the sides facing one another). For example, the first layer and the second layer (on the sides facing one another) can have a (surface) flatness of at most 50 μm, in particular at most 10μm, in accordance with DIN ISO 1101. In other words, the first layer and the second layer (on the sides facing one another) can have a surface flatness, wherein all points of the surface lie within a distance of at most 50 μm, in particular at most 10 μm, between two parallel planes.

The second layer can project at least partially laterally beyond the first layer. It can also be provided that the first layer projects at least partially laterally beyond the second layer.

An immersion medium can be introduced between an objective of the optical device, in particular a microscope objective, and the first layer, as a result of which the intermediate spaces are filled. Alternatively, a region between objective and sample can be free of immersion medium. A distance between objective and first layer (working distance) can be between 90 μm and 250 μm, in particular between 100 μm and 150 μm—for example when using an immersion medium. A distance between objective and first layer (working distance) can also be between 0.5 mm and 10 mm, in particular between 2 mm and 4 mm—for example without using an immersion medium.

A bridge thickness and/or a thickness of the second layer can be between 50 μm and 500 μm, in particular between 100 μm and 300 μm. The bridge thickness can be smaller than the working distance (of the microscope objective). The bridge thickness can be equal to a thickness of the remaining region of the second layer.

A thickness of the first layer can be between 40 μm and 500 μm, in particular between 130 μm and 170 μm.

The at least one bridge can have a variable width. For example, the at least one bridge can be at least 20% wider (in particular at least 50% wider, specifically at least 80% wider) in a widest section than in a narrowest section.

The at least one bridge can be widened (formed) towards the center point of the opening. For example, the at least one bridge can be at least 20% wider (in particular at least 50% wider, specifically at least 80% wider) in a central section/center point section (of the opening) than in an edge section (of the opening).

Alternatively, the at least one bridge can be widened towards the edge of the opening. For example, the at least one bridge can be at least 20% wider (in particular at least 50% wider, specifically at least 80% wider) in an edge section (of the opening) than in a central section/center point section (of the opening).

The widening can change (increase or decrease) linearly in the radial direction. Thus, an interface between the bridge and the adjacent partial opening can be formed rectilinearly at least in sections. Alternatively, the widening can increase superlinearly or sublinearly in the radial direction. Thus, an interface between the bridge and the adjacent partial opening can be formed curved at least in sections.

The second layer can be formed (at least partially) from a metal, in particular from steel, aluminum, or copper. For example, the second layer can be a metal sheet.

The first layer can be formed (at least partially) from glass (e.g., borosilicate glass, quartz glass), or plastic (e.g., polycarbonate, polymethyl methacrylate, polyethylene). In particular, the first layer can be a coverslip or a Petri dish base.

The bridge or the bridges can be formed integrally with the second layer. Alternatively, the bridge or the bridges can be formed from a different material than a remaining part of the second layer. Overall, the second layer can be formed integrally. The first layer and the second layer can be formed from the same material or from different materials. The first layer and the second layer can also be formed integrally with one another.

The second layer can be formed as an exchangeable component. For example, the holding device can have an insertion mechanism for the second layer. Additionally or alternatively, the second layer can be fastenable in the holding device by means of at least one of clamping fastening means, snap fastening means, plug fastening means, magnetic fastening means, screw closure, and (releasable) adhesive.

The holding device can have a heating element, wherein the holding device is configured to supply heat from the heating element to the sample and/or the first layer via the at least one bridge. In particular, the heating element can be connected and/or coupled to the sample and/or the first layer in a thermally/thermally conductive manner. In particular, the second layer can be physically connected to the heating element directly or via a holding structure. The heating element can be arranged on the holding structure. The second layer can be arranged on or on the holding structure. At least one of the first layer, the second layer, and the holding structure can be formed at least partially from thermally conductive material.

The holding structure can be arranged around the objective, for example. A thickness of the holding structure can be greater than the working distance.

The holding device can also have a plurality of heating elements, which can in particular be arranged surrounding the second layer, in particular at uniform distances. In this manner, a spatially uniform supply of heat to the sample can be achieved. For example, the heating elements can be arranged in such a manner that one heating element aligned with the bridge is provided per bridge end.

The first layer and the second layer can be connected to one another by means of a connecting material. The connecting material can have at least one of adhesive bonding, thermally conductive paste, thermally conductive pad, and oil. In other words, the connecting layer (between first layer and second layer) can have at least one of adhesive bonding, thermally conductive paste, thermally conductive pad, and oil.

The holding device can further have a chamber which is connected to the first layer or to the second layer in a sealed manner, is filled with a fluid, and surrounds the sample. In particular, the sample can thus be surrounded by the fluid. Separating elements can be arranged on the first layer (and optionally the second layer) within the chamber, for example for segmenting the chamber into segments separated from one another. The separating elements can be connected peripherally to a chamber wall of the chamber. The separating elements can be connected to the first layer and/or the second layer and/or the chamber wall in a sealed manner. The separating elements can be arranged aligned and/or aligned with the bridges.

Alternatively (if no chamber is provided), the sample can be (completely) surrounded by a fluid drop.

The sample can comprise, for example, biological cells, biological tissue, proteins, nanoparticles, crystalline materials, microstructured materials, polymers or a combination thereof. The first layer can be formed in particular transparently for visible light. The fluid can have, for example, at least one of water, buffer solution, nutrient medium, oil, alcohol, saline solution, and solvent.

The holding device can have the probe microscope probe. The probe microscope probe can be a scanning probe microscopy probe, for example an atomic force microscopy probe, a scanning tunnel microscopy probe or a magnetic force microscopy probe. The probe microscope probe can have a cantilever and a (probe) tip. The holding device can have the microscope objective. The optical device and/or the objective can be arranged below the second layer. The sample can be examinable by means of the objective (by light) through the opening and/or partial openings.

In conjunction with the method for probe microscopy and optical methods, the configurations described above in connection with the holding device can be provided accordingly. In connection with the present disclosure, interval specifications (“between”, “from . . . to”) are to be understood as encompassing the interval ends. In the present case, width directions and length direction relate to longitudinal directions of the first layer and/or second layer. Thickness directions relate to directions orthogonal to longitudinal directions of the first layer and/or second layer. The designation “radial” can in the present case also comprise directions toward the center point or away from the center point of a polygon, in particular of a square. In the case of a polygon, the term “diameter” denotes the greatest distance between two arbitrary points of the polygon. Designations such as “top” “above” or “bottom” “below” including corresponding modifications serve merely for the relative orientation and can also in each case denote the opposite direction.

### BRIEF DESCRIPTION OF THE DRAWINGS

Further exemplary embodiments are explained in more detail below with reference to figures of a drawing. In the figures:

FIG. 1 shows an arrangement for probe microscopy and optical microscopy according to the prior art,

FIG. 2a shows a side view of a holding device for probe microscopy and optical methods according to one embodiment of the invention,

FIG. 2b shows a plan view of the holding device,

FIG. 3a shows a side view of a holding device according to a further embodiment,

FIG. 3b shows a plan view of the holding device, and

FIG. 4 shows a side view of a holding device according to a further embodiment.

### DETAILED DESCRIPTION OF THE PREFERRED EMBODIMENTS

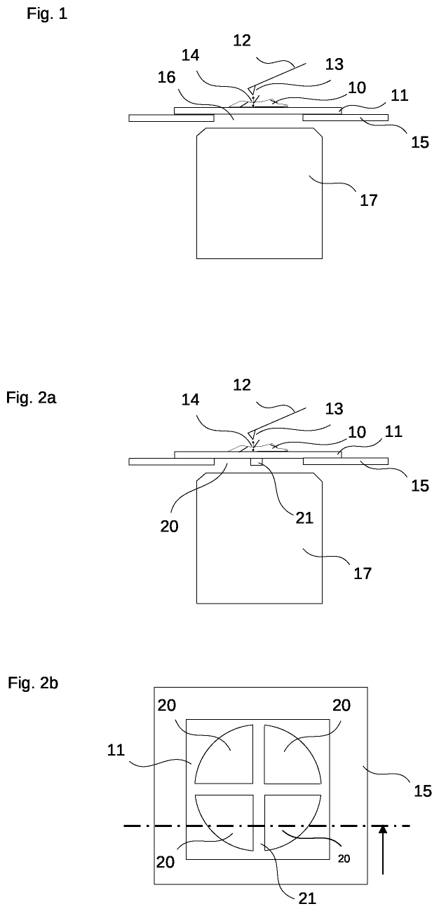

FIG. 1 shows an arrangement for probe microscopy and optical microscopy according to the prior art, in which a compromise can be achieved between stability and accessibility for a probe microscopic examination method and a further examination method (for example a light microscopic examination method). A sample 10 is arranged on a transparent first layer 11. A probe of a probe microscope can be introduced from above, which probe is illustrated here by way of example as a cantilever 12 with a tip 13 of a scanning force microscope. A distance 14 between tip 13 and sample 10 and an exact movement of cantilever 12 and tip 13 with respect to the first layer 11 or the sample 10 in one or more spatial directions can be set or carried out, for example, by means of piezo elements (not illustrated).

The first layer 11 is arranged above a second layer 15 with a central opening 16. The opening 16 permits an observation from below, for example by means of a (microscope) lens 17 of a light microscope. In this case, the first layer 11 can oscillate like a tympanic membrane and thereby influence the distance 14 in an undesired manner in addition to the intended change in distance.

FIGS. 2a and 2b show a holding device for probe microscopy and optical methods according to one embodiment of the invention in a side view and a plan view (without probe elements). FIG. 2a illustrates a sectional view along the section depicted in FIG. 2b.

The first layer 11 is supported by a stabilizing second layer 15 which has an opening 16 formed with four partial openings 20 in the present case. Alternatively, for example, two, three, or more than four partial openings can be formed. The bridges 21 ensure stability of the first layer 11. The first layer 11 illustrated in FIG. 2b is formed transparently and thereby reveals the second layer 15 supporting it together with its partial openings 20 and bridges 21. The two illustrated bridges 21 intersect orthogonally and form a cross which divides the opening 16 into four partial openings 20 formed as circular sectors/quadrant circles. In the present case, the first layer 11 has a smaller area than the second layer 15. Alternatively, the first layer 11 can also be larger than the second layer 15 and project approximately partially laterally beyond the second layer 15. Optical measurements take place through regions of the partial openings 20.

The second layer 15 can be configured exchangeably, in particular as (exchangeable) metal sheet. This makes it possible to install different layers without exchanging the entire device or parts of the device. New demands on the second layer 15 can thus also be realized in existing devices.

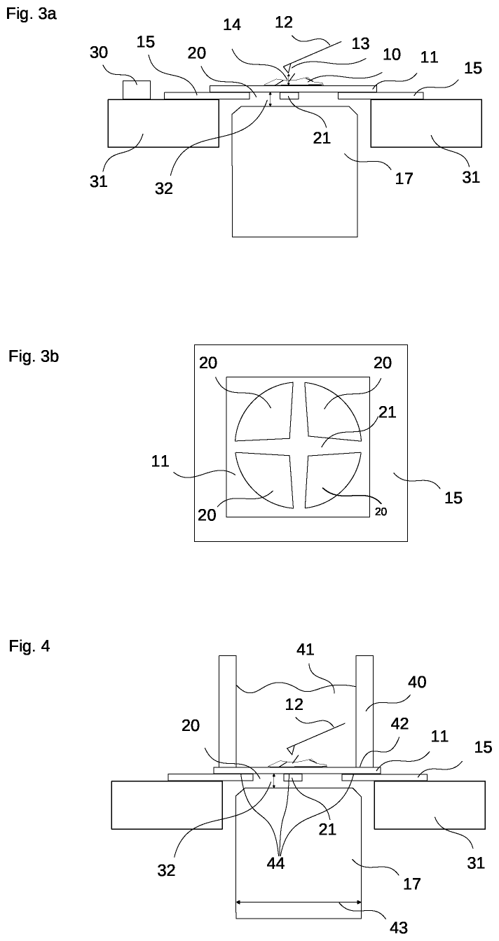

FIGS. 3a and 3b show a holding device according to a further embodiment in a side view and a plan view. In addition, a heating element 30 is provided for heat transfer to the first layer 11 and the sample 10, which heating element is in particular arranged peripherally, for instance on a holding structure 31. The holding structure 31 can be thicker than a working distance 32 (free working distance—FWD) between the underside of the first layer 11 and objective 17. This can be necessary in particular for objectives 17 with a small working distance 32 in order to further increase the stabilization. The heat is transferred from the heating element 30 via the holding structure 31 to the second layer 15. For this purpose, the material of the second layer 15 in particular consists of a thermally conductive material such as, for instance, metal. The bridges 21 distribute the heat to the first layer 11 and thus to the sample 10.

Without the second layer 15 with the bridges 21, in particular if the first layer 11 were connected directly to the holding structure 31 or directly to the heating element 30, the heat transfer would have to be undertaken by the first layer 11 itself, which, however, regularly consists of a poorly thermally conductive material such as, for example, glass. Thus, a more efficient supply of heat via the bridges 21 and the thickness direction of the first layer 11 to the sample 10 is made possible.

As shown in FIG. 3b, in the present configuration, the bridges 21 are widened towards the center of the opening 16. In this manner, in comparison with the parts arranged closer to the heating element 30, the parts of the bridges 21 which are cooler towards the center can transfer more heat over a larger area, such that a more uniform temperature control of the sample 10 can be made possible. This is the case in particular if the second layer 15 is heated from a plurality of sides.

FIG. 4 shows a holding device according to a further configuration with a chamber 40 which contains a fluid 41, for example water, by which the sample 10 and the cantilever 12 are surrounded. In this case, a seal 42 is provided between the chamber 40 and the first layer 11. In this configuration, too, the second layer 15 serves for stabilization, in particular if the diameter of the chamber 40 has a smaller diameter than the diameter 43 of the objective 17, and no stabilizing structures are provided in the chamber 40 itself, which is regularly the case. Stabilization can be important in particular if a large lateral adjustment is intended to take place between objective 17 and first layer 11.

Furthermore, a connection beyond gravity and adhesion between the first layer 11 and the second layer 15 together with the bridges 21 can make further stabilization possible. The corresponding connecting layer 44 can be realized, for example, by means of adhesive bonding, a thermally conductive paste, oil, or another releasable or non-releasable connection.

The present disclosure is not restricted to the above embodiments, but rather can be modified by a person skilled in the art within the scope of the claims. The present disclosure also encompasses, in its technical scope, any embodiment which is derived by combining technical means which are optionally disclosed in different embodiments.

1. A holding device for probe microscopy and optical methods, comprising:
an at least partially transparently formed first layer for receiving a sample which can be examined by means of a probe microscope probe guided from above, and
a second layer below the first layer for stabilizing the first layer, wherein the second layer has an opening for optical methods which is formed with at least two partial openings which are separated from one another by at least one bridge.

2. The holding device according to claim 1, wherein the opening is formed with at least three partial openings.

3. The holding device according to claim 1, wherein at least two of the partial openings have areas of different sizes.

4. The holding device according to claim 1, wherein the at least one bridge has a variable width.

5. The holding device according to claim 1, wherein the at least one bridge is widened towards the center point of the opening.

6. The holding device according to claim 1, wherein the second layer is at least partially formed from a metal.

7. The holding device according to claim 1, wherein the second layer is formed as an exchangeable component.

8. The holding device according to claim 1, further comprising a heating element, wherein the holding device is configured to supply heat from the heating element to the sample via the at least one bridge.

9. The holding device according to claim 1, wherein the first layer and the second layer are connected to one another by means of a connecting material.

10. The holding device of claim 9, wherein the first layer and the second layer are connected to one another by means of at least one of adhesive bonding, thermally conductive paste, thermally conductive pad, and oil.

11. The holding device according to claim 1, further comprising a chamber which is connected to the first layer or to the second layer in a sealed manner, wherein the chamber is filled with a fluid and surrounds the sample.

12. A method for probe microscopy and optical methods, comprising:
providing an at least partially transparently formed first layer and a sample on the first layer,
providing a second layer below the first layer for stabilizing the first layer, wherein the second layer has an opening which is formed with at least two partial openings which are separated from one another by at least one bridge, and
at least one of examining and manipulating the sample by means of a probe microscope probe guided from above and by means of an optical device through the opening.
